(19) United States
(12) Patent Application Publication
(10) Pub. No.: US 2017/0026085 A1
(43) Pub. Date: Jan. 26, 2017

(54) Resident ROV Signal Distribution Hub

(71) Applicant: Oceaneering International, Inc., Houston, TX (US)

(72) Inventors: Kevin Francis Kerins, The Woodlands, TX (US); Christopher Francis Mancini, Houston, TX (US); Peter Andrew Robert Moles, Cypress, TX (US)

(73) Assignee: Oceaneering International, Inc., Houston, TX (US)

(21) Appl. No.: 15/217,797

(22) Filed: Jul. 22, 2016

Related U.S. Application Data
(60) Provisional application No. 62/196,759, filed on Jul. 24, 2015.

(51) Int. Cl. H04B 3/58; E21B 41/00; E21B 17/00; H04B 11/00

(52) U.S. Cl. CPC H04B 3/58; H04B 11/00; E21B 41/0007; E21B 17/003

(57) ABSTRACT

A subsea umbilical and signal distribution hub (SDH) comprises a signal source, the signal comprising power and/or data; one or more signal carriers operatively in communication with the signal source; and a subsea signal distribution hub, which comprises a signal input connector operatively in communication with the signal carrier and a signal output connector operatively in communication with the signal input connector. Signals may be provided by deploying a device such as remotely operated vehicle (ROV) subsea; deploying a riser tension and mounting system (RTMS) with a resident ROV (RROV) installed; deploying a jumper from the RTMS to the RROV; operatively connecting the jumper to a signal distribution hub with such as via an ROV; and once in place, switching the signal on at the signal distribution hub.

### RELATION TO OTHER APPLICATIONS

This application claims priority through U.S. patent application Ser. No. 62/196,759 titled “Resident ROV power distribution hub” and filed on Jul. 24, 2015.

### FIELD OF THE INVENTION

Many offshore oilfields comprise multiple subsea wells spread out over a large area. These wells are typically clustered together in groups and tied back to a central production platform such as a floating vessel located near an oil platform (a floating production storage and offloading vessel or FPSO) via subsea umbilicals that provide power and data conduits for controlling and monitoring the wells remotely. These well clusters can be several miles from the production platform.

Due to the large separation distance between wells and production platform, any maintenance or repair must be carried out using some form of in-field support vessel. This work almost always involves the use of a remotely operated vehicle (ROV) installed on the vessel.

In-field support vessels are expensive to operate and are frequently unable to work due to adverse weather conditions. If work is required in multiple locations simultaneously, then more than one vessel is required.

The challenge is to provide an alternative to in-field support vessels that is more cost-effective and can work regardless of weather conditions.

### FIGURES

The figures supplied herein illustrate various embodiments of the invention.

FIG. 1 is a block schematic diagram of an exemplary embodiment of the claimed invention;

FIG. 2 is a block diagram of a signal distribution hub comprising a plurality of inputs and outputs;

FIG. 3 is a block schematic diagram of a further exemplary embodiment of the claimed invention;

FIG. 3 is a block schematic diagram of a further exemplary embodiment of the claimed invention;

FIG. 4 is a block schematic diagram of a further exemplary embodiment of the claimed invention;

FIG. 5 is a block schematic diagram of a further exemplary embodiment of the claimed invention; and

FIG. 6 is a block schematic diagram of a further exemplary embodiment of the claimed invention.

### DESCRIPTION OF VARIOUS EMBODIMENTS

Referring to FIG. 1, in a first embodiment a subsea umbilical and signal distribution hub (SDH) system comprises signal source 1, signal carrier 7 operatively in communication with the signal source 1, and SDH 10. As used herein, “signal” may be a power signal, a data signal, or the like, or a combination thereof, including electromagnetic signals and fiber optic signals.

SDH 10 may be gravity-based, or affixed to the seabed via pin pile. As more fully described herein below, in embodiments SDH 10 comprises one or more power/data receptacles for connecting to subsea devices; one or more power/data receptacles which may be configured to accept either jumper leads for routing power/data to remote devices or directly-mounted devices or the like; electrical power switching and management controls; data switching and management controls; and/or one or more acoustic transceivers for communicating with subsea positioning equipment, e.g. acoustic transponders, acoustic modems, and the like, or a combination thereof.

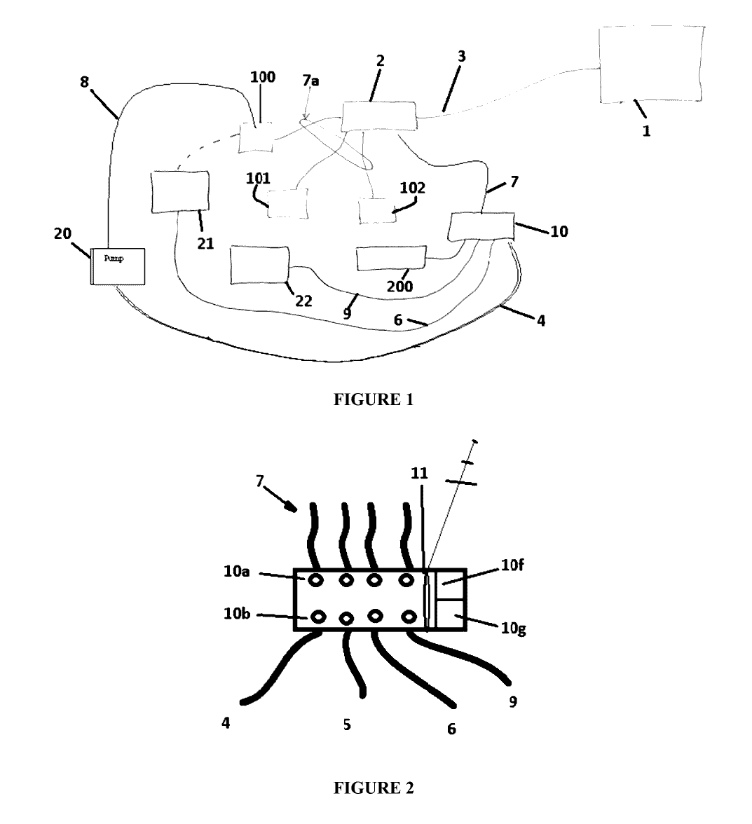

Referring additionally to FIG. 2, SDH 10 typically comprises one or more signal input connectors 10a operatively in communication with one or more signal carriers 7 and one or more signal output connectors 10b operatively in communication with at least one signal input connector 10a. In embodiments signal output connector 10b comprises a plurality of such signal output connectors, where each signal output connector 10b of the plurality of signal output connectors is typically operatively in communication with one or more signal input connectors 10a and further adapted to be connected to one or more signal output carriers such as signal carriers 4, 5, 6, and 9.

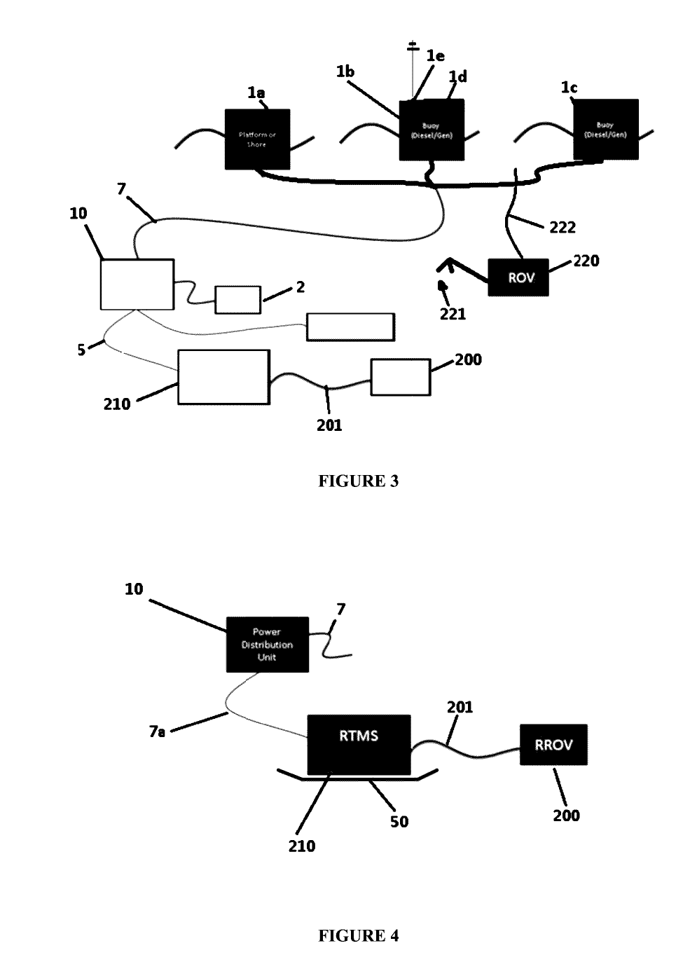

Referring back to FIG. 1, signal source 1 may comprise a power signal source, a data signal source, or the like, or a combination thereof. If a power signal source is present, the power signal source may comprise platform based power source 1a (FIG. 3), buoy-based power source 1b (FIG. 3), shore-based power source 1c (FIG. 3), or the like, or a combination thereof.

Buoy-based power sources 1b (FIG. 3) may comprise one or more single or dual/redundant power generation systems 1d (FIG. 3) that can be easily refueled by a vessel of opportunity and may further comprise one or more data transmitters 1e (FIG. 3) configured to communicate to a remote data receiver, such as a platform or shore based data receiver. Data transmitters 1e may communicate via satellite or cellular communications or the like.

Signal input connector 10a may be configured to accept a jumper lead, such as signal carrier 7, for routing power to a remote device such as RROV 200 and/or a directly-mounted device. Additionally, signal output connector 10b may be configured to provide a signal received via the signal carrier 7 to a subsea device, by way of example and not limitation such as via signal carrier 5 to subsea pump 20.

Where SDH 10 is configured to receive and distribute a power signal, SDH 10 may further comprise signal switch 10f (FIG. 2) configured as an electrical power switch and signal manager 10g (FIG. 2) configured as a power manager operatively disposed intermediate signal input connector 10a and signal output connector 10b.

Where SDH 10 is configured to receive and distribute a data signal, e.g. from data source 1a, SDH 10 may further comprise one or more signal input connector 10a configured as input data connectors operatively in communication with signal source 1a configured as a data source and one or more output signal output connectors 10b configured as data connectors operatively in communication with input data connector 10a. Additionally, in this embodiment SDH 10 may further comprise signal switch 10f (FIG. 2) configured as a data switch and signal manager 10g (FIG. 2) configured as a data manager operatively disposed intermediate signal input connector 10a and signal output connector 10b.

Referring back to FIG. 1, in a further embodiment, umbilical terminator 2, which may be a pre-existing umbilical terminator assembly, may be present, operatively in communication with signal source 1 and have pre-existing umbilical connections to subsea equipment and wells such as via umbilical 7a, and disposed intermediate signal source 1 and SDH 10 signal input connector 10a. Typically, in this embodiment signal carrier 7 is operatively in communication with umbilical terminator 2 and, accordingly, with signal source 1 via umbilical terminator 2 and umbilical terminator 2 is operative to provide a signal received from signal source 1 to SDH 10 signal input connector 10a via signal carrier 7. By way of example and not limitation, signal source 1 may provide a signal to umbilical terminator 2 via umbilical 3 and then that signal received at umbilical terminator 2 may be provided to SDH 10 signal input connector 10a via signal carrier 7 where signal carrier 7 is operatively connected to umbilical terminator 2.

In other embodiments, referring generally to FIG. 3, signal carrier 7 is dedicated to SDH 10 and completely isolated from another umbilical such as umbilical 3 which may be used to control and/or monitor a well 100.

In certain embodiments SDH 10 further comprises transceiver 11 (FIG. 2), which may be an acoustic transceiver, operatively in communication with SDH 10.

In the operation of exemplary embodiments, SDH 10 typically operates as a subsea signal hub to provide a signal pathway to RROV 200 and/or other devices that reside permanently at or proximate to well cluster 100-102. As discussed below, SDH 10 may also be used for other purposes, including signal communications to and from RROV 200, an autonomous underwater vehicle (not shown in the figures), and/or a hybrid system (not shown in the figures); powering high-power subsea devices and systems such as dredge unit 22, flow assurance systems such flowline remediation and well stimulation system 21, and/or various subsea pumping and injections systems such as pump 20; powering asset integrity equipment 21; and/or providing emergency power/data to one or more subsea wells 100-102 in the event of failure of the primary control umbilical such as by using a secondary source.

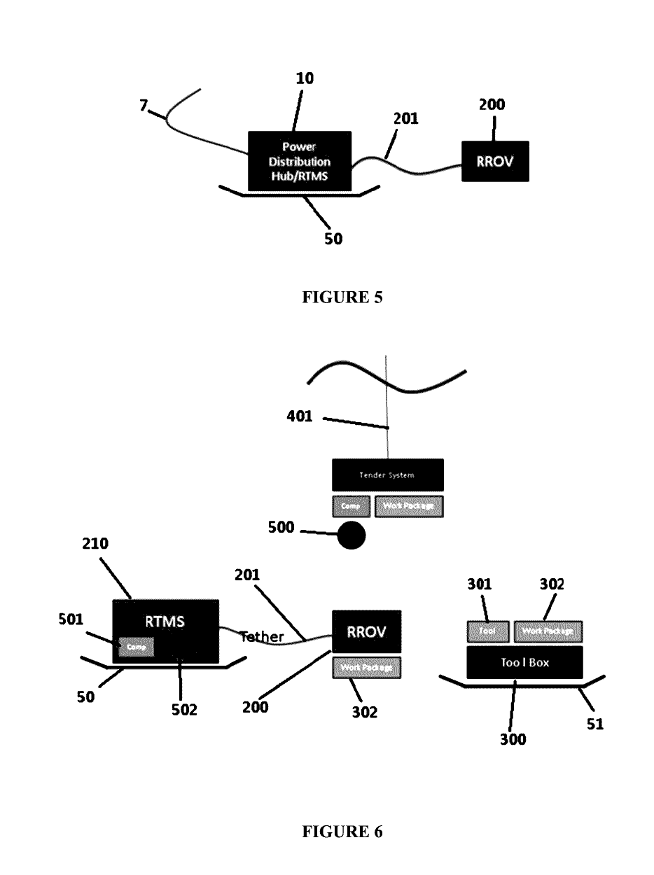

Referring generally to FIGS. 3-6, in a first operative embodiment, a signal may be provided to a subsea device such as pump 20, subsea dredge 22, RROV 200, wells 100-102, or the like, or a combination thereof, via SDH 10, which is as described above, by disposing SDH 10 subsea and disposed SDH umbilical 7 proximate to a seafloor. SDH 10 may be affixed to the seabed via a pin pile or the like.

SDH umbilical 7, which may be dedicated to SDH 10 or connected to SDH 10 from another device such as umbilical terminator 2, operatively connects SDH 10 to signal source 1, directly or indirectly, and SDH signal output connector 10b is made available for connection to a subsea device such as RROV 200, an autonomous underwater vehicle (not shown in the figures), a hybrid system (not shown in the figures), a high-power subsea device such as high-power subsea dredge unit 22, a flow assurance system, a subsea pump 20, a subsea injections system, and/or asset integrity equipment 21, or the like, or a combination thereof. RROV 200 may be an RROV residing permanently at or proximate to well cluster 100-102.

Once connected, a signal may be received from signal source 1, where, as noted before, the signal comprises a power signal and/or a data signal, and the received signal provided to the subsea device via one or more SDH signal output connectors 10b.

In certain embodiments, SDH 10 may be used to provide emergency power/data to well 100-102 in the event of failure of a primary control umbilical.

Referring to FIG. 1, in an embodiment power and control may be accessed from an existing umbilical such as umbilical 3 using spare conductors and fibers. The signal may be provided to SDH 10 via signal carrier 7 which may comprise a flying lead 7a.

In this or other embodiments, a signal may be provided to a subsea device via SDH 10, which is as described above, by deploying a device such as ROV 200 subsea; deploying a riser tension and mounting system (RTMS) such as RTMS 210 (FIG. 3), e.g. by lowering RTMS 210, with RROV 200 installed, such as by using fast-line 401; deploying jumper 5, which may be lowered or removed, from RTMS 210; connecting jumper 5 to SDH 10 such as via ROV 220 or RROV 200; and once in place, switching the signal on at SDH 10.

RROV 200 may be used as well to connect a power and/or other umbilical such as signal carrier 4 to a subsea device from SDH 10.

Once a signal task is completed, RROV 200 may be flown out such as with a full tether; a predetermined set of RROV and RTMS function checks may be completed; and RROV 200 may be returned to RTMS 210.

In either method, a signal check, such as a communication and/or power signal check, may be performing after the signal is switched on, i.e. made available via SDH 10.

In a further embodiment, signal carrier 7 may be a dedicated subsea umbilical used with SDH 10, as illustrated in FIG. 4. Umbilical 7 may be laid on the seafloor from production platform 1a (FIG. 3) or shore 1c (FIG. 3) or the like to well cluster 100-102, where it terminates in SDH 10. In certain of these embodiments umbilical 7 may be completely isolated from those that control and monitor wells 100-102 themselves and pose little to no risk to the oil production process.

Referring to FIG. 2, in a further embodiment, dedicated signal carrier 7 which may be a subsea umbilical is provided from buoy 1b or surface 1c and connected to SDH 10. In this case as well, umbilical 7 may be completely isolated from those that control and monitor wells 100-102 themselves and pose little to no risk to the oil production process. Buoy 1b may contain a single power generation system 1d or dual/redundant power generation systems 1d that can be refueled by such as by a vessel of opportunity. Buoy 1b may further communicate to platform 1a or shore 1c such as via satellite or cellular communications.

In certain embodiments, one or more devices such as ROV 220 may be deployed subsea, such as by using fast-line 401, and RTMS 210 lowered with RROV 200 installed. RTMS 210 and RROV 200 can then be rested on the seafloor such as via mud-mat 50. One or more jumpers 5 may be lowered or removed from RTMS 210 and connected to SDH 10 with such as via ROV 220. Once in place, power and communications may be switched on at SDH 10. Optionally, communication and power checks may be performed.

As needed, RROV 210 may be flown out with full tether and RROV and RTMS function checks completed. RROV 210 may be used as well to connect a power and/or other umbical such as 4 to a subsea device such as pump 20, subsea dredge 22, asset integrity system 21, or the like, from SDH 10.

Once connected, RROV 200 may be returned to RTMS 210 and, as needed, functions such as maintenance checks completed.

In a further embodiment, RTMS 210 may be lowered with RROV 200 installed using, e.g., ROV umbilical 222, and rested on the seafloor such as with mud-mat 50. RROV 200 may be deployed and jumper 5 lowered and/or removed from RTMS 210 and connected to SDH 10. Power and/or communications may be switched on at SDH 10 and RROV 200 returned to RTMS 210.

Once a signal such as power is available at SDH 10, that signal may be provided from SDH 10 to field internal power on RTMS 210 such as by using power switch 10f. Communication and power checks may be performed. Once the desired task, e.g. provision of power and/or data, is completed, RROV 200 may be flown out such as with a full tether 201 and RROV and RTMS function checks completed. RROV 200 may be returned to RTMS 210 and maintenance checks may be completed, e.g. recompensation and the like. A clump-on fast-line may be deployed (if not deployed with RTMS 210) and the umbilical removed from RTMS 210 and connected to the clump-on fast-line. Optionally, one or more components, e.g. RROV 200, may then be recovered to the surface.

With respect to intervention type operations, during inspection RROV 200 may be navigated to subsea hardware such as Christmas trees, manifolds, UTA 2, and the like. If so equipped, video cameras may be used to inspect the hardware for damage, corrosion or leakage. One or more tools such as electric brush tools may be used to clean surfaces as necessary and one or more used to access areas as necessary, e.g. an electric suction pump.

RROV 200 may be used to operate hardware valves and/or for installation of flying leads, such as by flying RROV 200 to the hardware; docking tool 301 such as an integrated electric torque tool into an appropriate receptacle; and opening and/or closing the valve as required, which may comprise counting turns, monitoring torque, and the like, or a combination thereof. As illustrated in FIG. 6, tool 301 may be part of or otherwise accessible from tool box 300 and/or part of work package 302.

RROV 200 may be used to obtain cathodic protection (CP) readings by flying RROV 200 to the hardware, placing a probe at a pre-defined location, and taking one or more readings. This may be repeated as necessary.

RROV 200 may be used for fluid injection operations by flying RROV 200 to the desired hardware, docking a hot stab tool into an appropriate receptacle; and, using an HPU on RROV 200, powering a desired tree function. Once completed, the hot stab may be removed.

Referring now to FIG. 6, RROV 200 may be used to support other tools subsea as well, such as pump 20 (FIG. 1) and/or subsea dredge 22 (FIG. 1) and/or tool 301. In an embodiment, a tool such as tool 301 may be lowered to the sea bed such as by using tool deployment frame 300 and/or a fast line 401. Alternatively, tool 301 may already be present such as in subsea tool box 300 or as part of work package 302. In such embodiments, RROV 200 acquires tool 301 and, if needed, plugs hot stab 221 (FIG. 3) into tool 301. If not at the correct location, RROV 200 flies tool 301 to a desired location. Using an HPU aboard RROV 200, tool 301 may then be operated as required. In a further tool support embodiment, for electric tools a motor driver available via RROV 200 may be used to operate tool 301 in place or alongside the HPU and, in such embodiments, RROV 200 connected to tool 301 via an appropriate electrical connector. Once the desired operation is completed, hot stab 221 is removed and the tool returned to a tool deployment frame or a subsea tool box.

Referring still to FIG. 6, in a further embodiment RROV 200 may be used to fill and/or refill one or more compensation/hydraulic reservoirs 500. In a first fill/refill embodiment, compensation and hydraulic oil refill system 500, which may be built into tool deployment frame 300, is filled such as on a deck of a vessel (not shown in the figures). Typically, tool deployment frame 300 is lowered such as to mudline 51 using fast-line 401 and a fill line connected from a bladder to an RTMS fill port. Once connected, a fill valve is opened on RTMS 210 and, using a mechanical rotary interface on RROV 200, plugged into refill system pump drive 501. Fluid is then pumped until a predetermined RTMS bladder pressure is achieved. When such pressure is achieved or it is otherwise deemed required, RROV 200 is undocked from the tool deployment frame refill pump system and the fill valve on RTMS 210 is closed.

In a second fill/refill embodiment, RROV 200 closes one or more isolation valves on an empty compensation system 502 on RTMS 210. Fast-line 401 is lowered and connected to empty compensation system 502 on RTMS 210 which is then unlocked and returned to a location such as a surface location using fast-line 401. Once at the surface, compensation system 502 is refilled and inspected for damage, wear, and the like. If it passes inspection, compensation system 502 is returned to RTMS 210 using fast line 401 and docked and locked to RTMS 210. Once docked and locked, one or more isolation valves is opened and pressures confirmed.

In the operation of a further embodiment, ROV 220 is deployed and RROV 200 ensured to be properly secured inside RTMS 210. Power and/or communications are switched off at SDH 10. Jumper 5 (FIG. 3) is disconnected from RTMS 210 and optionally stored. Fast-line 401 is lowered and connected to RTMS 210 and, once connected, RTMS 210 is recovered to a surface location.

In a further embodiment, RROV 200 may be replaced and/or changed-out subsea by flying RROV 200 outside of RTMS 210 and deploying ROV 220. Fast-line 401 is lowered and secured to RROV 200 and power and/or communications switched off at SDH 10. Tether 201 is disconnected from RROV 200 and may be recovered into RTMS 210. RROV 200 may then be recovered to the surface location.

Once any of the above operations are completed, RROV 200 may be undocked from RTMS 210.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A subsea umbilical and signal distribution hub (SDH), comprising:
a. a signal source;
b. a signal carrier operatively in communication with the signal source; and
c. a subsea signal distribution hub anchored subsea, the subsea signal distribution hub comprising:
i. a signal input connector operatively in communication with the signal carrier; and
ii. a signal output connector operatively in communication with the signal input connector.

2. The subsea umbilical and signal distribution hub (SDH) of claim 1, wherein the signal output connector further comprises a plurality of signal output connectors, each signal output connector of the plurality of signal output connectors operatively in communication with the signal input connector.

3. The subsea umbilical and signal distribution hub (SDH) of claim 1, wherein the signal source comprises a power signal source.

4. The subsea umbilical and signal distribution hub (SDH) of claim 3, wherein the power signal source comprises a platform based power source, a shore-based power source, or a buoy-based power source.

5. The subsea umbilical and signal distribution hub (SDH) of claim 4, wherein the buoy-based power source comprises a single or dual/redundant power generation system.

6. The subsea umbilical and signal distribution hub (SDH) of claim 4, wherein the buoy-based power source comprises a refillable power source.

7. The subsea umbilical and signal distribution hub (SDH) of claim 4, wherein the buoy-based power source comprises a data transmitter configured to communicate data to a remote data receiver via satellite or cellular communications.

8. The subsea umbilical and signal distribution hub (SDH) of claim 1, further comprising an umbilical terminator operatively in communication with the signal source and disposed intermediate the signal source and the subsea signal distribution hub signal input connector, the signal carrier operatively in communication with the umbilical terminator, the umbilical terminator operative to provide a signal received from the signal source to the subsea signal distribution hub signal input connector via the signal carrier.

9. The subsea umbilical and signal distribution hub (SDH) of claim 1, wherein the signal carrier is dedicated to the subsea signal distribution hub from the signal source and completely isolated from another umbilical used to control and/or monitor a well.

10. The subsea umbilical and signal distribution hub (SDH) of claim 1, wherein:
a. the signal source comprises a power signal source; and
b. the subsea signal distribution hub further comprises:
i. an electrical power switch; and
ii. an electrical power manager operatively disposed intermediate the signal input connector and the signal output connector.

11. The subsea umbilical and signal distribution hub (SDH) of claim 1, wherein:
a. the signal source further comprises a data source; and
b. the subsea signal distribution hub further comprises:
i. an input data connector operatively in communication with the data source; and
ii. an output data connector operatively in communication with the input data connector.

12. The subsea umbilical and signal distribution hub (SDH) of claim 11, wherein the subsea signal distribution hub further comprises:
a. a data switch; and
b. a data switch manager operatively disposed intermediate the output data connector and the input data connector.

13. The subsea umbilical and signal distribution hub (SDH) of claim 1, further comprising an acoustic transceiver operatively in communication with the SDH.

14. The subsea umbilical and signal distribution hub (SDH) of claim 1, wherein the signal input connector is configured to accept a jumper lead for routing power to a remote device and/or to a directly-mounted device.

15. The subsea umbilical and signal distribution hub (SDH) of claim 1, wherein the signal output connector is configured to provide a signal received via the signal carrier to a subsea device.

16. A method of providing a signal to a subsea device via a subsea umbilical and signal distribution hub (SDH), the SDH comprising a signal source, a signal carrier operatively in communication with the signal source, and a subsea signal distribution hub, the subsea signal distribution hub comprising a signal input connector operatively in communication with the signal carrier and a signal output connector operatively in communication with the signal input connector, the method comprising:
a. disposing the SDH subsea proximate to a seafloor;
b. disposing a dedicated SDH umbilical proximate to a seafloor;
c. connecting the dedicated SDH umbilical to the subsea signal distribution hub and to a signal source;
d. connecting the SDH signal output connector to a subsea device;
e. receiving a signal from the signal source, the signal comprising a power signal or a data signal; and
f. providing the signal received from the signal source to the subsea device via the SDH signal output connector.

17. The method of providing a signal to a subsea device of claim 16, further comprising securing the SDH to the seabed via a pin pile.

18. The method of providing a signal to a subsea device of claim 16, wherein the subsea device comprises a Resident ROV (RROV), an autonomous underwater vehicle (AUV), a hybrid system, a high-power subsea device, a high-power subsea dredge unit, a flow assurance system, a subsea pumping, a subsea injections system, and/or an asset integrity equipment.

19. The method of providing a signal to a subsea device of claim 18, wherein the RROV comprises an RROV residing permanently at or proximate to a subsea well.

20. A method of providing a signal to a subsea device via a subsea umbilical and signal distribution hub (SDH), the SDH comprising a signal source, a signal carrier operatively in communication with the signal source, and a subsea signal distribution hub, the subsea signal distribution hub comprising a signal input connector operatively in communication with the signal carrier and a signal output connector operatively in communication with the signal input connector, the method comprising:
a. deploying a device subsea;
b. deploying a riser tension and mounting system (RTMS) with a resident remotely operated vehicle (RROV) installed;
c. deploying a jumper from the RTMS, the jumper operative in communication with the signal source;
d. connecting the jumper to a signal distribution hub; and
e. once in place, making a signal from the signal source available via the signal distribution hub.
